(19) United States
(12) Patent Application Publication
(10) Pub. No.: US 2026/0163796 A1
(43) Pub. Date: Jun. 11, 2026

(54) METHOD FOR CONFIGURING AN INTERNET OF THINGS DEVICE FOR CONNECTION TO A MESH NETWORK

(71) Applicant: 5321 Innovation Labs LLC, Franklin, MA (US)

(72) Inventors: Edward W. Neipris, Wrentham, MA (US); Mikenzie Reeder Wade, Castle Rock, CO (US); Tyler Richard Nesper, Denver, CO (US); David R. Doiron, Franklin, MA (US)

(21) Appl. No.: 19/407,383

(22) Filed: Dec. 3, 2025

Related U.S. Application Data
(60) Provisional application No. 63/730,250, filed on Dec. 10, 2024.

(51) Int. Cl. H04L 41/0806; H04L 41/08; H04W 84/18; H04W 88/16

(52) U.S. Cl. CPC H04L 41/0806; H04L 41/0886; H04W 84/18; H04W 88/16

(57) ABSTRACT

An Internet of Things (IoT) mesh network designates one or more IoT devices in the network as managing devices responsible for autoconfiguring other IoT devices within range. As part of the configuration process, the managing devices listen for configuration request signals transmitted by IoT devices in need of configuration. Upon detecting a device in need of configuration, a managing device identifies the device type and compares it against a set of filter rules. If the filter rules support configuration, the managing device establishes a direct connection with the device in need of configuration and pushes a configuration. As part of the push configuration, the device receiving the configuration may be designated as an additional managing device. By increasing the number of managing devices, the range and speed of automatic configuration available within the mesh network is effectively enhanced.

### CROSS-REFERENCE TO RELATED APPLICATIONS

The present invention claims the benefit under 35 U.S.C. 119(e) to U.S. Provisional Patent Application No. 63/730,250, which was filed on Dec. 10, 2024, in the names of Edward W. Neipris et al., the disclosure of which is incorporated herein by reference.

### FIELD OF THE INVENTION

The present invention relates generally to the field of wireless networks and, more particularly, to methods for configuring Internet of Things (IoT) devices for connection to mesh networks.

### BACKGROUND OF THE INVENTION

An Internet of Things (IoT) device is an internet-enabled device that is designed principally to collect and wirelessly transmit data for use in a variety of different applications. IoT devices are prevalent in a wide range of consumer products (e.g., smartwatches, smart televisions, and smart home appliances), healthcare products (e.g., fitness trackers and smart vital sign monitors), industrial products (e.g., machine sensors and tracking devices), and building management products (e.g., smart lighting, air quality sensors, and security cameras). Data compiled from IoT devices can be utilized to, inter alia, regulate environmental conditions, monitor patient health, and optimize the efficiency of routine business operations.

In certain environments, multiple IoT devices work in concert to compile a collection of data that is used to create a smart ecosystem. In all settings, each IoT device requires individualized configuration for connection to the internet in order to transmit the compiled data.

To facilitate connection of multiple IoT devices to the internet within a general area, an IoT mesh network, or mesh network, is often established. In prior art FIG. 1, an illustrative mesh network is shown, the mesh network being identified generally by reference numeral 11. As can be seen, mesh network 11 is a decentralized, non-hierarchical, wireless network in which individual nodes are configured to selectively connect to one another in a defined mesh-like structure to transmit data based on defined protocols.

As represented herein, mesh network 11 comprises a gateway node, or gateway, 13 that connects mesh network 11 to the internet. An array of endpoint nodes, or endpoints, 15-1 thru 15-9 is provided, each endpoint 15 representing any wireless device that is designed to compile and transmit data via the internet (e.g., an IoT device). Mesh network 11 additionally includes a set of repeater nodes, or repeaters, 17-1 thru 17-3, which serve to pass data between gateway 13 and endpoints 15. Each repeater 17 represents any device that is designed to expand the wireless coverage afforded by network 11, such as an access point (AP) or range extender.

Mesh networks of the type as described above offer a number of notable advantages including, but not limited to, (i) seamless and expansive wireless coverage afforded by the multiple repeaters, (ii) reliable and self-healing network connectivity due to its decentralized construction and inherent efficiency to re-route data, as needed, (iii) scalability (i.e., the ability to readily incorporate additional nodes), and (iv) energy and cost savings achieved through the implementation of power saving protocols.

Traditionally, management of IoT devices is handled through a Mobile Device Management (MDM) platform. As defined herein, an MDM platform represents any software, service, or device that directly connects with/to an IoT device (e.g., an IoT broker, IoT controller, IoT gateway, smartphone, or other similar wireless device). Using the MDM platform, the party responsible for managing IoT devices can modify existing settings, add new settings, or completely reconfigure each device.

However, when in its initial factory default mode, an IoT device is typically incapable of being contacted by an MDM platform. Instead, at the time of first use, an IoT device requires a configuration process in order to establish, inter alia, a connection of the IoT device to a network (e.g., mesh network 11), IoT controller, MDM platform, and/or any other appropriate device.

To illustrate the typical configuration process, endpoint 15-10 in FIG. 1 represents an IoT device that has not yet been configured to receive internet access from mesh network 11. To obtain internet access, endpoint 15-10 requires the implementation of a network configuration process in order to establish its connection parameters (i.e., the assignment of network settings, policies, data flows, and controls), the established network connection for endpoint 15-10 being represented generally by reference number 19. This network configuration process is often achieved either through (i) a manual configuration process on the IoT device itself (e.g., through a touchscreen or other similar interactive controls) or (ii) a designated software application on a secondary device (e.g., a smartphone) in connection therewith (e.g., after receiving a Wi-Fi beacon from the IoT device).

As can be appreciated, the aforementioned process that is required to initially configure each IoT device for connection to a mesh network is highly tedious and labor intensive. In fact, even when multiple IoT devices are concurrently installed in a common environment (e.g., as a collection of devices that together form a smart ecosystem), there currently exists no means to simplify or streamline the initial configuration process. Instead, each device typically requires its own individualized configuration process, which, as noted above, is largely manual. As a result, conventional processes for performing large-scale installations of IoT devices are both time consuming and inefficient. Additionally, since IoT device configurations rely upon a considerable manual component, there is introduced a greater likelihood of configuration error during the process.

### SUMMARY OF THE INVENTION

In view thereof, it is an object of the present invention to provide a novel method for configuring an Internet of Things (IoT) device for connection to a mesh network.

It is another object of the present invention to provide a method of the type as described above wherein connectivity established with the mesh network is seamless, reliable, scalable, and cost efficient.

It is yet another object of the present invention to provide a method of the type as described above wherein multiple IoT devices can be configured for connection in a simple, efficient, and largely automated manner.

Accordingly, as one feature of the present invention, there is provided a mesh network comprising an Internet of Things (IoT) mesh network, comprising (a) a gateway for providing internet access, and (b) a plurality of endpoints, each endpoint requiring configuration in order to establish communication with the gateway, (c)) wherein a selection of the plurality of endpoints is designated as a set of managing endpoints, each of the set of managing endpoints being adapted to detect and automatically configure a selection of the plurality of endpoints that require configuration.

As another feature of the present invention, there is provided a method for configuring an Internet of Things (IoT) device for connection to a mesh network, the mesh network comprising a plurality of IoT devices, the method comprising the steps of (a) designating a selection of the plurality of IoT devices as a set of managing devices, each of the set of managing devices being adapted to detect and automatically configure a selection of the plurality of IoT devices requiring configuration, (b) identifying a first IoT device from the selection of the plurality of IoT devices requiring configuration by a first managing device from the set of managing devices, and (c) automatically pushing a configuration from the first managing device directly to the first IoT device requiring configuration.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified block diagram of an illustrative prior art Internet of Things (IoT) mesh network which is useful in understanding the conventional process for configuring an IoT device for connection thereto;

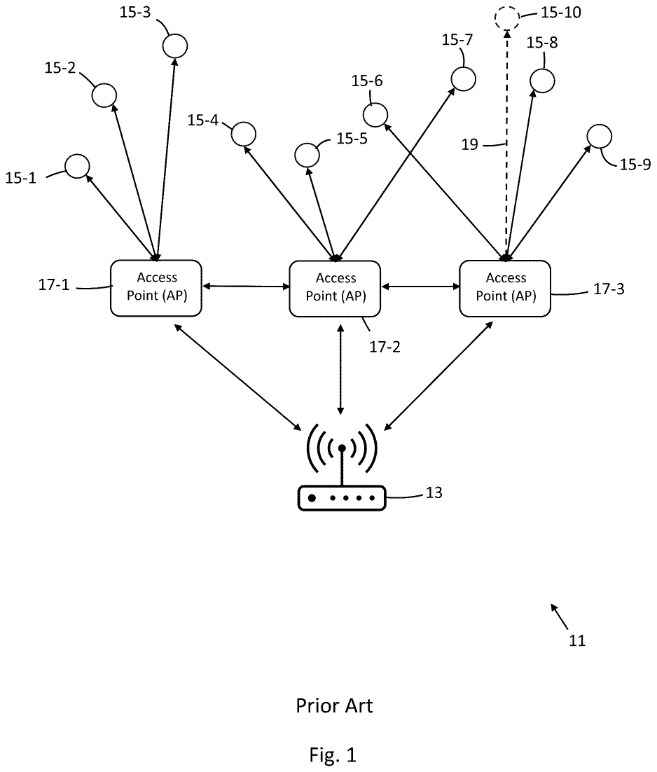

FIG. 2 is a simplified block diagram of an illustrative IoT mesh network which is useful in understanding a novel process for configuring an IoT device for connection thereto, the process being implemented according to the teachings of the present invention; and

FIG. 3 is a flow chart depicting the novel process for configuring an IoT device for connection to a mesh network as shown in FIG. 1.

### DETAILED DESCRIPTION OF THE INVENTION

### Internet of Things (IoT) Mesh Network 111

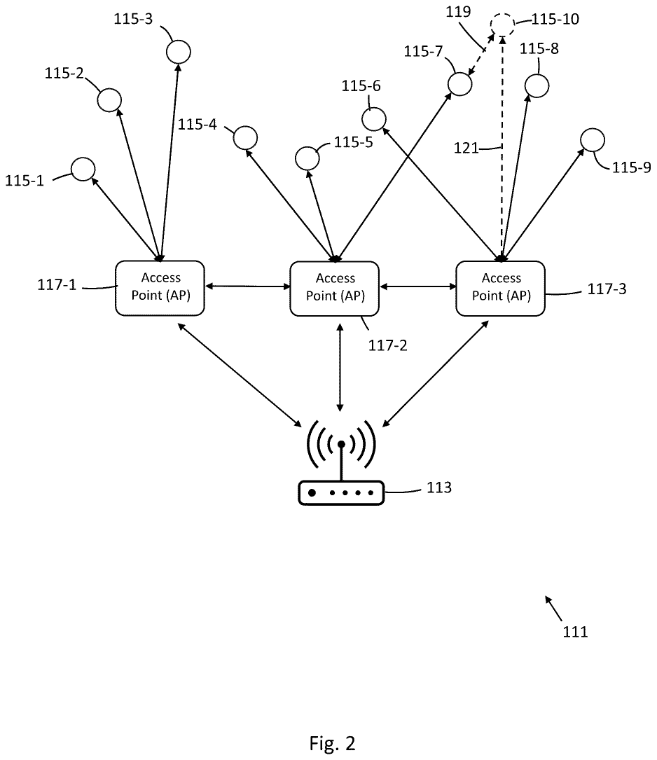

Referring now to FIG. 2, there is shown a simplified block diagram of an illustrative Internet of Things (IoT) mesh network that is useful in understanding a novel process for configuring an IoT device for connection thereto, the mesh network being identified generally by reference numeral 111. As will be explained in detail below, IoT mesh network 111 designates one or more selected IoT devices to initially configure, or reconfigure, the connection parameters for other IoT devices. As a result, internet access can be established for IoT devices through a configuration process that is largely automated and highly streamlined.

As can be seen, IoT mesh network 111 is similar to prior art IoT mesh network 11 in that IoT mesh network 111 comprises (i) a gateway node, or gateway, 113, which represents any device designed to connect mesh network 111 to the internet (e.g., a router), (ii) an array of endpoint nodes, or endpoints, 115-1 thru 115-9, each endpoint 115 representing any wireless device designed to compile and transmit data via the internet (e.g., an IoT device), and (iii) a set of repeater nodes, or repeaters, 117-1 thru 117-3, each repeater 117 representing any device designed to expand the wireless coverage afforded by network 111 (e.g., an access point (AP) or range extender). As referenced briefly above, mesh network 111 differs from prior art mesh network 11 in that mesh network 111 is designed to implement a novel process for configuring the connection parameters of endpoints 115, which will be explained in detail below.

It should be noted that mesh network 111 is not limited to any particular number, type, and/or arrangement of nodes. Rather, it is to be understood that the particular selection and interrelationship between gateway 113, endpoints 115, and repeaters 117 are provided herein strictly for illustrative purposes. In fact, due to its scalable design, mesh network 111 is constructed to readily incorporate additional nodes, as needed.

It should be also noted that each endpoint 115 is designed only to compile and transmit its own data. As represented herein, endpoints 115 are not configured to relay data compiled by other nodes.

As referenced above, IoT mesh network 111 is uniquely designed to designate one or more selected IoT devices to initially configure, or reconfigure, the connection parameters for other IoT devices in the network. Endpoints 115 designated to configure other IoT devices are referred to herein as primarily configured, controlling, or managing endpoints 115.

For example, in FIG. 2, endpoint 115-10 represents an IoT device that not yet been configured to receive internet access from mesh network 111 and, in turn, management through an associated MDM platform. Additionally, endpoint 115-7 represents an IoT device designated as a managing endpoint. Therefore, to obtain internet access, primarily configured endpoint 115-7 temporarily connects with unconfigured endpoint 115-10, as represented by reference numeral 119. Once connected, managing endpoint 115-7 pushes the network configuration onto new endpoint 115-10. As a result, new endpoint 115-10 establishes its connection parameters with network 111 (i.e., the assignment of network settings, policies, data flows, and controls), the newly established network connection for endpoint 115-10 being represented generally by reference number 121. The details of this automated device-to-device configuration process are set forth below.

### IoT Device Configuration Process 211

As referenced above, mesh network 111 is uniquely designed to implement a novel process for configuring an endpoint (e.g., an IoT device) for network connection, the process being identified generally herein using reference numeral 211. More specifically, configuration process 211 designates a selection of endpoints to autoconfigure other endpoints. As a result, method 211 enables a large number of IoT devices to be configured for connection to a mesh network in a quick and efficient fashion.

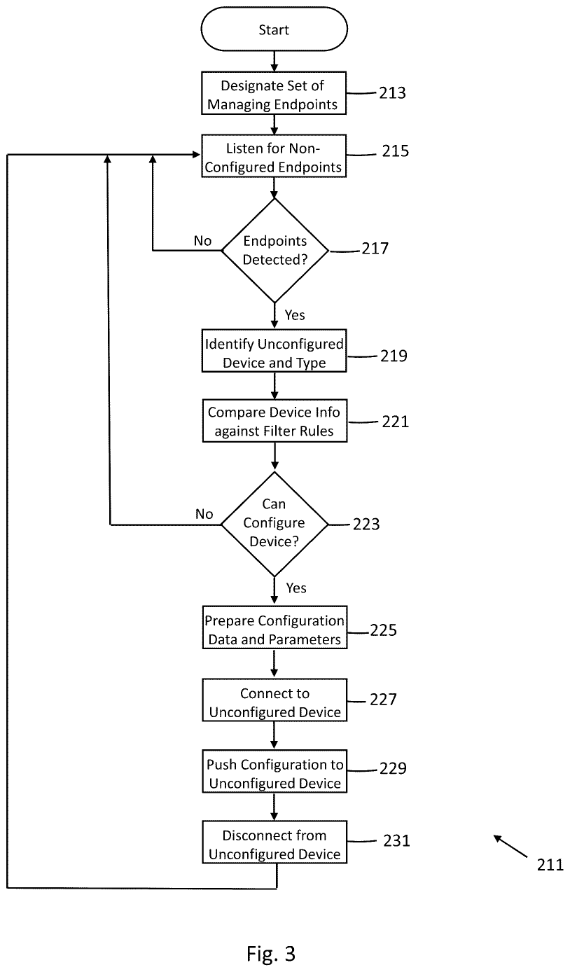

Referring now to FIG. 3, there is shown a simplified flow chart of network configuration process, or method, 211. As can be seen, process 211 commences by designating a selection of endpoints 115 to function as the primarily configured, or managing, endpoints 115 within mesh network 111, this endpoint designation step being represented generally by reference numeral 213 in FIG. 3.

For simplicity, method 211 is described herein as assigning a single endpoint 115-7 as a managing endpoint. However, it is to be understood that multiple endpoints 115 could be designated in mesh network 111 to optimize efficiency.

Additionally, it should be noted that managing endpoint 115-7 is described herein primarily as identifying and configuring new (i.e., non-connected) endpoints 115. However, it is to be understood that, in addition to configuring new endpoints 115, managing endpoint 115-7 could also be responsible for reconfiguring existing (i.e., connected) endpoints 115 when needed.

Managing endpoint 115-7 is represented herein as an IoT device that is configured and enabled to propagate configurations to other IoT devices. Managing endpoint 115-7 may be in the form of, inter alia, (i) an IoT device installed with a custom-designed application for handling configuration propagations and related functions, (ii) an IoT device with pre-installed coding or programming for handling configuration propagations and related functions, or (iii) an IoT device with an application-specific integrated circuit (IC) for handling configuration propagations and related functions.

Enabling, or activating, a propagation configuration feature installed on a managing endpoint 115-7 could be accomplished via, but not limited to, (i) instructions transmitted using mobile device management (MDM) software, (ii) instructions transmitted from an external software application on a secondary device (e.g., a smartphone), or (iii) manual controls, such as a touchscreen or interactive display panel. In a similar fashion, a propagation configuration feature could be disabled, or deactivated, on an endpoint, if desired (e.g., to conserve power).

Upon completion of step 213, managing endpoint 115-7 listens, or scans, for other endpoints 115 requesting initial configuration (e.g., via transmission of a periodic beacon or other similar configuration request signal), as represented by step 215 in FIG. 3. Listening step 215 can be accomplished using any known short-range wireless communication protocol (e.g., the Bluetooth, Zigbee, Z-Wave protocol, Wi-Fi, Network Broadcast Messaging, Long Range Wide Area Network (LoRaWAN), or Matter communication protocols).

As part of a detection step 217, managing endpoint 115-7 determines if any endpoints 115 currently require configuration. If no unconfigured endpoints 115 are detected, process 211 returns to listening step 215. However, if an endpoint requiring configuration is detected (e.g., endpoint 115-10), managing endpoint 115-7 identifies the non-configured device as well as its device type, as represented by identification step 219 in FIG. 3.

Identification step 219 could be implemented using various techniques including, but not limited to, device fingerprinting, retrieval of the device Media Access Control (MAC) address, or transmission of device information in the configuration request signal.

Upon completion of identification step 219, managing endpoint 115-7 cross-references the retrieved device information against a set of filter rules to determine if managing endpoint 115-7 should be responsible for propagating a configuration to the detected endpoint 115-10, this cross-referencing step being identified generally by reference numeral 221 in FIG. 3.

As part of a determination step 223, process 211 returns back to listening step 215 if the filter rules stipulate that managing endpoint 115-7 should not be responsible for propagating a configuration to the detected endpoint 115-10. However, if the filter rules stipulate that managing endpoint 115-7 should be responsible for propagating a configuration to the detected endpoint 115-10, process 211 advances to a configuration preparation step 225.

As part of step 225, managing endpoint 115-7 prepares the configuration data and connection parameters to be applied to the unconfigured endpoint 115-10. These connection parameters may be in the form of, inter alia, a copy of the configuration for the managing endpoint 115-7, a configuration template provided to the managing endpoint 115-7, or a custom configuration provided to the managing endpoint 115-7 for one or more specific devices. Managing endpoint 115-7 may retrieve these connection parameters from, inter alia, an MDM platform, an external software application, or an internal instruction set.

Once the configuration data and parameters are prepared, the primarily configured endpoint 115-7 connects to the unconfigured endpoint 115-10 as part of a connection step 227. In order to establish connection with new endpoint 115-10, managing endpoint 115-7 may be required to temporarily disconnect from its primary connectivity path to mesh network 111. Connection between endpoints 115 can be established using either a custom-designed communication protocol or a standard communication protocol (e.g., the Bluetooth, Zigbee, Z-Wave protocol, Wi-Fi, Network Broadcast Messaging, Long Range Wide Area Network (LoRaWAN), or Matter communication protocols).

Once connection is established between managing endpoint 115-7 and unconfigured endpoint 115-10, managing endpoint 115-7 pushes the configuration onto unconfigured endpoint 115-10 as part of a push step 229. Push step 229 can be performed using any data transfer technique, such as, but not limited to, file transfer, Hypertext Transfer Protocol Secure (HTTPS) encryption, Secure Shell (SSH), and Message Queuing Telemetry Transport (MQTT) protocols.

After the configuration is transferred to the unconfigured endpoint 115-10, managing endpoint 115-7 disconnects from the newly configured device as part of a disconnect step 231. Additionally, if managing endpoint 115-7 was required to temporarily disconnect from its primary connectivity path in order to connect with unconfigured endpoint 115-10, managing endpoint 115-7 reestablishes its primary connectivity path with mesh network 111.

Thereafter, managing endpoint 115-7 may be instructed to verify the configuration of newly configured endpoint 115-10. This verification could be accomplished by, inter alia, (i) sending a data request (e.g., a ping) to newly configured endpoint 115-10, or (ii) requesting data back from newly configured endpoint 115-10.

Once disconnect step 231 is completed, process 211 returns to step 215. As such, managing endpoint 115-7 reassumes its responsibility to listen for other endpoints 115 in need of initial configuration or reconfiguration.

As part of the above-described process for configuring new endpoint 115-10, the configuration may designate new endpoint 115-10 as an additional managing device designed to listen for and propagate configurations to other endpoints 115. Accordingly, by designating an increasing number, or chain, of endpoints to function as managing endpoints, the range of automated configuration available within mesh network 111 is effectively expanded.

It should be noted that automated configuration process 211 has particular usefulness in settings where multiple device IoT devices are installed at the same time. Illustrative examples of IoT devices which are often concurrently installed include (i) a smart television, a smart set-top box (STB), and smart speakers, (ii) a smart lock, a smart doorbell, and smart cameras, and (iii) a set of smart light bulbs and smart thermostat. When a single technician is required to bulk configure multiple IoT devices as part of a large-scale deployment (e.g., throughout a multi-dwelling unit (MDU), hotel, or office complex), autoconfiguration process 211 provides an exponential reduction in the required onboard labor time. As an additional benefit, utilizing a configuration process that is largely automated eliminates the risk of human error.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. An Internet of Things (IoT) mesh network, comprising:
(a) a gateway for providing internet access; and
(b) a plurality of endpoints, each endpoint requiring configuration in order to establish communication with the gateway;
(c) wherein a selection of the plurality of endpoints is designated as a set of managing endpoints, each of the set of managing endpoints being adapted to detect and automatically configure a selection of the plurality of endpoints that require configuration.

2. The IoT mesh network as claimed in claim 1 further comprising at least one repeater for relaying communications between the gateway and the plurality of endpoints.

3. The IoT mesh network as claimed in claim 1 wherein at least one of the plurality of endpoints is in the form of an IoT device that is designed to compile and transmit data.

4. The IoT mesh network as claimed in claim 3 wherein a first managing endpoint from the set of managing endpoints pushes a configuration onto a first endpoint requiring configuration from the selection of the plurality of endpoints that require configuration.

5. The IoT mesh network as claimed in claim 4 wherein the first managing endpoint applies a set of filter rules to determine whether to push the configuration onto the first endpoint requiring configuration.

6. The IoT mesh network as claimed in claim 5 wherein the set of filter rules is based on the device type of the first endpoint requiring configuration.

7. The IoT mesh network as claimed in claim 4 wherein the first managing endpoint establishes direct connection with the first endpoint requiring configuration prior to pushing the configuration.

8. The IoT mesh network as claimed in claim 7 wherein the direct connection established between the first managing endpoint and the first endpoint requiring configuration is temporary.

9. The IoT mesh network as claimed in claim 8 wherein each of the set of managing endpoints is configured to listen for a configuration request signal transmitted by any of the plurality of endpoints requiring configuration.

10. The IoT mesh network as claimed in claim 9 wherein the first endpoint requiring configuration is designated as one of the set of managing endpoints as part of the configuration.

11. A method for configuring an Internet of Things (IoT) device for connection to a mesh network, the mesh network comprising a plurality of IoT devices, the method comprising the steps of:
(a) designating a selection of the plurality of IoT devices as a set of managing devices, each of the set of managing devices being adapted to detect and automatically configure a selection of the plurality of IoT devices requiring configuration;
(b) identifying a first IoT device from the selection of the plurality of IoT devices requiring configuration by a first managing device from the set of managing devices; and
(c) automatically pushing a configuration from the first managing device directly to the first IoT device requiring configuration.

12. The method as claimed in claim 11 further comprising the step of, prior to the pushing step, determining the device type of the first IoT device requiring configuration.

13. The method as claimed in claim 12 further comprising the step of, after the determining step, comparing the device type of the first IoT device requiring configuration against a set of filter rules to determine whether to push the configuration.

14. The method as claimed in claim 13 further comprising the step of, prior to the pushing step, establishing a direct connection between the first managing device and the first IoT device requiring configuration.

15. The method as claimed in claim 14 wherein the identifying step is achieved through the transmission of a configuration request signal by the first IoT device requiring configuration.

16. The method as claimed in claim 15 wherein, as part of the pushing step, the first IoT device requiring configuration is designated as one of the set of managing devices.
